(19) United States
(12) Patent Application Publication
(10) Pub. No.: US 2002/0094778 A1
(43) Pub. Date: Jul. 18, 2002

(54) Bluetooth connection quality indicator

(76) Inventors: Joseph M. Cannon, Harleysville, PA (US); James A. Johanson, Macungie, PA (US)

Correspondence Address: Farkas & Manelli, PLLC, 7th Floor, 2000 M Street, NW, Washington, DC, 20036-3307, US

(21) Appl. No.: 09/761,774

(22) Filed: Jan. 18, 2001

(51) Int. Cl. H04B 5/00

(52) U.S. Cl. 455/41; 455/414; 455/502

(57) ABSTRACT

A wireless piconet device such as a BLUETOOTH conforming wireless piconet device includes a piconet connection quality determiner function and a corresponding visible or audible connection quality indication to a user, assisting the user in achieving optimal placement of individual devices in a piconet network. The connection quality indicator may be integrated into a BLUETOOTH device, or provided separately as a portable unit (e.g., hand held unit). In a preferred embodiment, the connection quality indicator provides a user with information relating to a quality of a connection, based on, e.g., RSSI and/or link quality.

### BACKGROUND OF THE INVENTION

1. Field of the Invention

The present invention relates to piconet wireless networks. More particularly, it relates to the implementation of a user friendly connection quality indicator in BLUETOOTHυ piconet type network devices.

2. Background of Related Art

Piconets, or small wireless networks, are being formed by more and more devices in many homes and offices. In particular, a popular piconet standard is commonly referred to as a BLUETOOTH piconet. Piconet technology in general, and BLUETOOTH technology in particular, provides peer-to-peer communications over short distances.

The wireless frequency of piconets may be 2.4 GHz as per BLUETOOTH standards, and/or typically have a 20 to 100 foot range. The piconet RF transmitter may operate in common frequencies which do not necessarily require a license from the regulating government authorities, e.g., the Federal Communications Commission (FCC) in the United States. Alternatively, the wireless communication can be accomplished with infrared (IR) transmitters and receivers, but this is less preferable because of the directional and visual problems often associated with IR systems.

A plurality of piconet networks may be interconnected through a scatternet connection, in accordance with BLUETOOTH protocols. BLUETOOTH network technology may be utilized to implement a wireless piconet network connection (including scatternet). The BLUETOOTH standard for wireless piconet networks is well known, and is available from many sources, e.g., from the web site www.bluetooth.com.

Short range wireless connections such as those offered by piconets in general, and BLUETOOTH conforming piconets in particular, while having many advantages provided by wireless connectivity, also inherently have a distinct disadvantage from wired connections. In particular, users of wireless piconet devices do not have information relating to placement of a piconet device in a location where a wireless signal will start to degrade.

In the example of piconets, the short-range wireless connection area is specified as approximately 10 Meters. However, in reality, the 10 Meter sphere is not always perfect. In particular, the range of a particular wireless device, and the quality of the wireless signal within that range, will have an irregular shape and distance depending on the design of the antenna. Additionally, based on the route or number of timeslots available, the data rate of the connection can vary widely.

While data rates can vary, signal quality may degrade as a result. Moreover, a BLUETOOTH device may be placed in a marginal location with respect to the antenna of another BLUETOOTH device in the piconet, nevertheless within range and specifications, but allowing only marginal communications data rates, thus causing degraded communications with the other BLUETOOTH device, unbeknownst to the typical user of the BLUETOOTH devices.

FIG. 5 shows an example placement of two wireless piconet devices 400, 410 in a piconet network with degradation in signal caused by a solid wall 402 between the two wireless piconet devices 400, 410.

In particular, in the given example, the power level of the wireless signal may be degraded because of the wall portion 402 in direct line between the wireless piconet devices 400, 410, as shown by path A in FIG. 5. However, communications may still nevertheless be established by a reflected signal in path B, but perhaps the reflected signal path exceeds 10 Meters, or is attenuated significantly due to the reflection, etc. While the communications quality is degraded, the piconet devices may be capable of communicating with low data rates, or low signal strength, or high error rates nevertheless, giving the user the false impression that the piconet network is in satisfactory operating condition. As may be seen in the depiction in FIG. 5, if either wireless piconet device 400, 410 is moved so as to allow direct communications there between, a greater signal quality may be achieved. However, because the wireless piconet devices appear to be operating satisfactorily, the user will leave the wireless piconet devices 400, 410 in their original locations.

As another real-world example, antenna design plays an important role in wireless communications, and each particular type antenna has its own coverage pattern.

For example, FIG. 6 shows an exemplary wireless piconet comprising three wireless piconet devices 500-504, including a first wireless piconet device 500 having an antenna exhibiting a particular coverage pattern 520.

In particular, as shown in FIG. 6, a wireless piconet device 500 may be placed by chance in such a position as to place another of the wireless piconet devices 502 in a disadvantageous location perhaps just missing reliable coverage by the coverage pattern 520 of the other wireless piconet device 500 in the relevant piconet. In such a situation, while communications are likely still possible between the wireless piconet devices 500, 502, if the user were to know of the disadvantageous placement of the wireless piconet device 500, they could merely rotate the one wireless piconet device 500 slightly to place the other wireless piconet device 502 comfortably within the coverage pattern 520. However, because communications occur between the wireless piconet devices 500, 502, albeit at a low data rate due to degraded communications conditions, the user will not be made aware of the degraded communications conditions.

There is a need for an apparatus and technique which allows piconet devices, and in particular BLUETOOTH piconet devices, to indicate to a user that they should be moved to more optimal locations with respect to one another to optimize short range communications capabilities.

### SUMMARY OF THE INVENTION

In accordance with the principles of the present invention, a wireless piconet device comprises a piconet front end, a piconet connection quality determiner, and a user link quality indicator. The piconet connection quality determiner determines at least one aspect relating to a quality of connection achieved through the piconet front end, and controls the user link quality indicator based on the determined at least one aspect.

A method of optimizing link quality of a wireless piconet device to a user in accordance with another aspect of the present invention comprises firstly determining at least one aspect of a link quality of a wireless connection to a short range network, and providing a first indication of compliance of the at least one aspect of the link quality to the user.

### BRIEF DESCRIPTION OF THE DRAWINGS

Features and advantages of the present invention will become apparent to those skilled in the art from the following description with reference to the drawings, in which:

FIG. 1 shows an exemplary piconet device, e.g., a BLUETOOTH conforming device, including a piconet connection quality determiner and user link quality indicator, in accordance with the principles of the present invention.

FIGS. 2A to 2C show various embodiments of the user link quality indicator shown in FIG. 1, in accordance with the principles of the present invention.

FIGS. 3A and 3B show detailed block diagrams of exemplary piconet connection quality determiners, in accordance with the principles of the present invention.

FIG. 4 shows an exemplary process of indicating wireless piconet connection quality to a user to allow the user to optimize the connection quality, in accordance with the principles of the present invention.

FIG. 5 shows an example placement of two wireless piconet devices in a piconet network with degradation in signal caused by a solid wall between the two wireless piconet devices.

FIG. 6 shows an exemplary wireless piconet comprising three wireless piconet devices, including a first wireless piconet device having an antenna exhibiting a particular coverage pattern.

### DETAILED DESCRIPTION OF ILLUSTRATIVE EMBODIMENTS

In accordance with the principles of the present invention, a wireless piconet device such as a BLUETOOTH wireless piconet device includes a piconet connection quality determiner function and a corresponding visible or audible connection quality indication to a user, assisting the user in achieving optimal placement of individual devices in a piconet network.

The connection quality indicator may be integrated into a BLUETOOTH device, or provided separately as a portable unit (e.g., hand held unit). In a preferred embodiment, the connection quality indicator provides a user with information and an indication relating to the shape, distance, data rate, and/or whether or not the relevant piconet device needs to be part of a longer-range connection such as a scatternet connection.

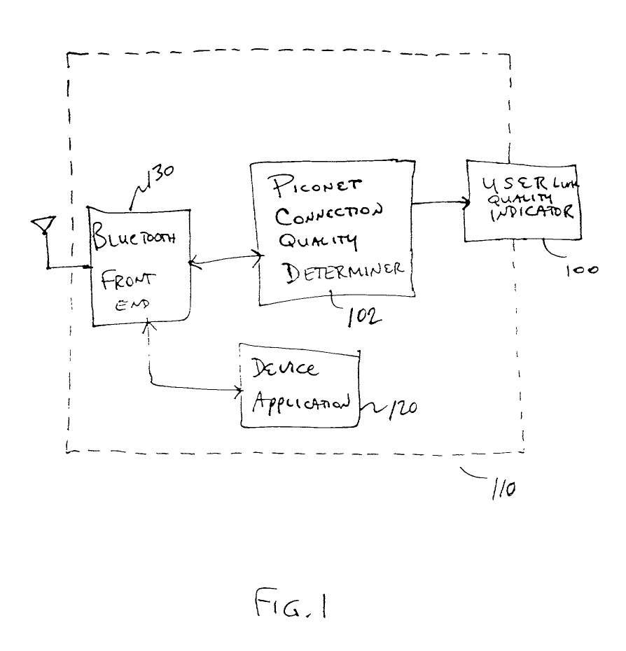

FIG. 1 shows an exemplary piconet device, e.g., a BLUETOOTH conforming device 110, including a piconet connection quality determiner 102 and user link quality indicator 100, in accordance with the principles of the present invention.

In particular, as shown in FIG. 1, the exemplary piconet device 110 includes a suitable wireless piconet front end and antenna 130 (e.g., BLUETOOTH conforming), and a suitable processor 120 including the functionality of the relevant device 110. The processor 120 may be based on any suitable logic device, e.g., a microprocessor, a microcontroller, or a digital signal processor (DSP).

Importantly, in accordance with the principles of the present invention, the wireless piconet device 110 further includes a piconet connection quality determiner 102, and a suitable audible or visible user link quality indicator 100.

The piconet connection quality determiner 102 determines one or more aspects of the quality of the wireless communications between one or more wireless piconet devices within a relevant piconet and/or scatternet network.

The user link quality indicator 100 may provide an audible and/or visual indication to the user as to a quality of the wireless communications with one or more other wireless piconet devices in a relevant piconet network. For instance, an LED may be lit, an audible sound such as a beep may be output by a speaker or buzzer device when the wireless piconet device 110 is above (or below) an acceptable connection quality threshold, and/or suitable connection quality information may be displayed to the user on a graphical display, e.g., LCD display.

The aspects of the quality of wireless communications are preferably determined substantially in real time, although a delay between the measurement of a particular aspect and ultimate presentation to the user via the user link quality indicator 100 is within the scope of the present invention.

The aspects of the quality of wireless communications with the relevant wireless piconet device 110 are preferably based on a received signal strength indicator (RSSI) or on link quality.

Aspects of the wireless communications which may be determined by the piconet connection quality determiner include, e.g., receive signal strength indicator (RSSI), data transfer, bit rate, error rate, and/or type of piconet connection.

The indication to the user from the user link quality indicator 100 may indicate that the signal strength or other aspect of the wireless communications is such that a longer range wireless connection (e.g., a scatternet) is achievable.

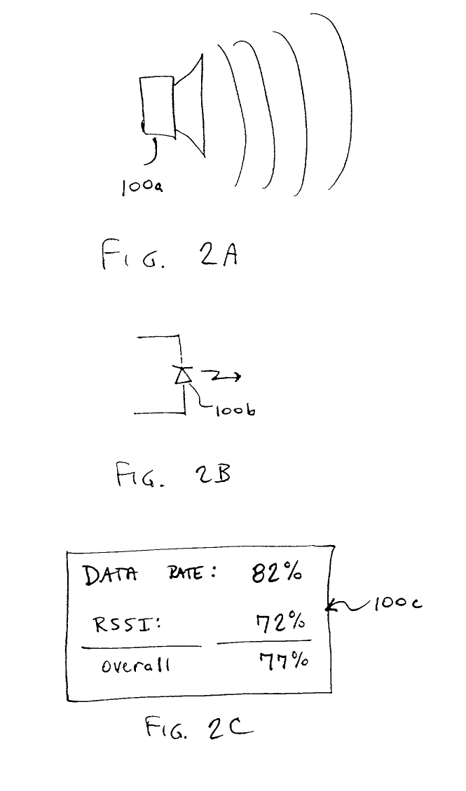

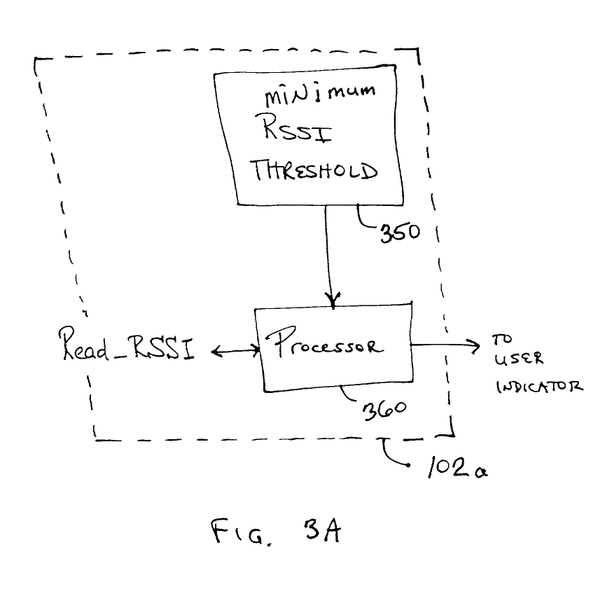

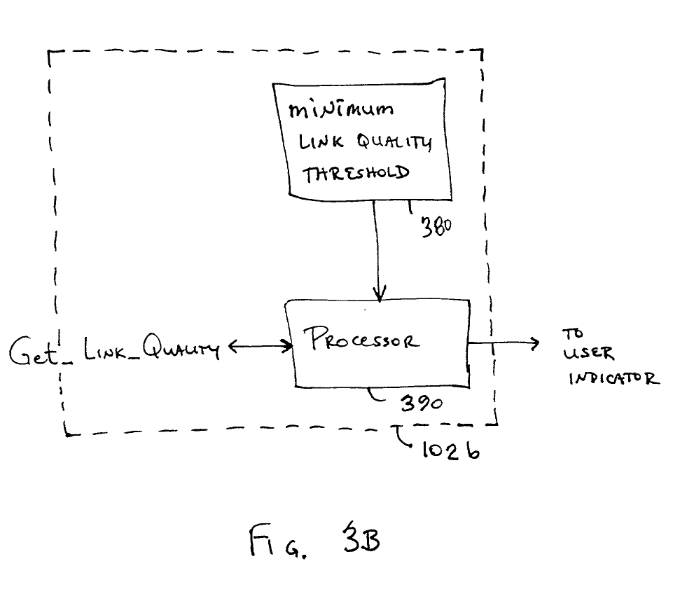

FIGS. 2A to 2C show various embodiments of the user link quality indicator 100 shown in FIG. 1, in accordance with the principles of the present invention.

In particular, as shown in FIG. 2A, the user link quality indicator 100 may include a speaker or buzzer device 100a. The speaker 100a may be used to provide an audible indication to the user relating to a present quality of wireless connections with respect to a particular location or wireless piconet device.

FIG. 2B shows an example user link quality indicator 100 comprising an LED 100b. The LED 100b may be lit to indicate that the relevant wireless piconet device is in a fringe area exhibiting marginal or less than desirable connection quality, based on, e.g., RSSI or link quality. Alternatively, the LED 100b may indicate the opposite, i.e., that the relevant wireless piconet device is exhibiting connection quality at or above a given threshold amount, e.g., of RSSI or link quality.

FIG. 2C shows an example graphical display indicating more substantive information relating to the connection quality. For instance, the graphical display may indicate an absolute value of the current bit rate, or a percentage of maximum possible bit rate as shown (e.g., 82% of maximum). The graphical display may further indicate additional information relative to communication quality, e.g., RSSI. The RSSI may be shown in any suitable form, e.g., as a percentage of maximum possible (or maximum realized) RSSI. Alternatively, the RSSI may be shown in absolute terms.

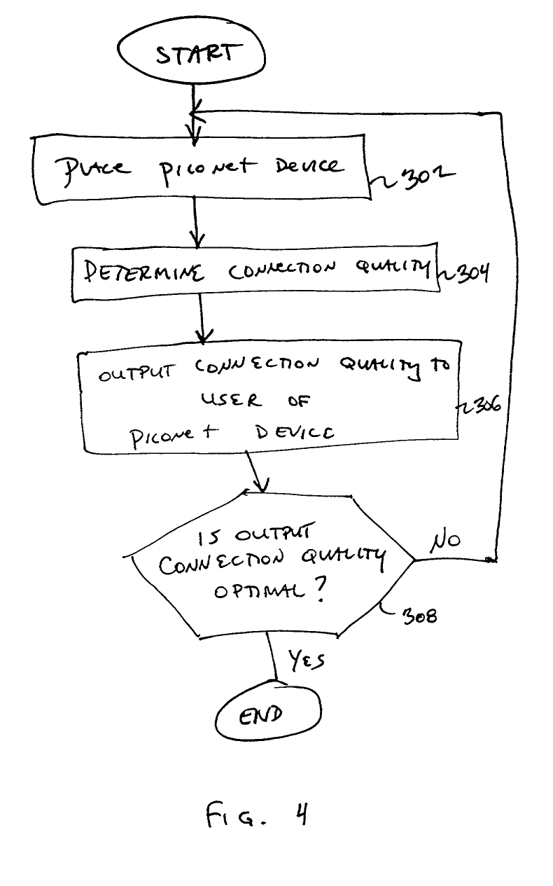

FIGS. 3A and 3B show detailed block diagrams of exemplary piconet connection quality determiners 102, in accordance with the principles of the present invention.

In particular, as shown in FIG. 3A, one embodiment of a piconet connection quality determiner 102a comprises a processor 360 (which may or may not be the same processor as processor 120 shown in FIG. 1), which generates a Read_RSSI command as described in the BLUETOOTH specification, available at http://www.bluetooth.com, the entirety of which is explicitly incorporated herein by reference.

The BLUETOOTH specification, provides a Host Controller Interface (HCI) command which obtains a value for RSSI from the baseband controller of the BLUETOOTH front end 130, appropriately named Read_RSSI. This allows the value of RSSI to be monitored by the host processor (120 in FIG. 1 and/or 360 in FIG. 3A) at the application layer.

The RSSI value is forwarded back to the processor 360, which compares the returned value with a pre-configured minimum RSSI threshold value 350 stored in an appropriate non-volatile memory. Based on a comparison of the returned RSSI value to the minimum RSSI threshold value 350, a control signal is output to the user link quality indicator 100.

In another embodiment shown in FIG. 3B, the piconet connection quality determiner 102 requests a link quality value using the Get_Link_Quality command described in the BLUETOOTH specification. The processor 390 compares a returned value of the link quality with a minimum link quality threshold value 380, and outputs a control signal to the user link quality indicator 100 based on such comparison.

In particular, the BLUETOOTH specification provides a way to measure the link quality of the relevant BLUETOOTH device using the well named Get_Link_Quality command. The higher the value of the returned link quality, (e.g., the higher the value between 0x00 and 0XFF), the better the link quality. The Get_Link_Quality command can be controlled by a host application (e.g., in the processor 390 in FIG. 3B).

The minimum RSSI threshold 350 shown in FIG. 3A and the minimum link quality threshold 380 may alternatively be expressed in terms of a maximum value. Moreover, the minimum RSSI threshold 350 and minimum link quality threshold 380 may be pre-configured by a manufacturer of the relevant piconet devices, by an appropriate network manager, or by the user themselves, based on the particular application, in accordance with the principles of the present invention.

While RSSI and link quality are shown in separate embodiments of a piconet connection quality determiner 102 in FIGS. 3A and 3B, a piconet connection quality determiner 102 may include a determination of both RSSI and link quality, as well as any other parameter relating to connection quality, in accordance with the principles of the present invention.

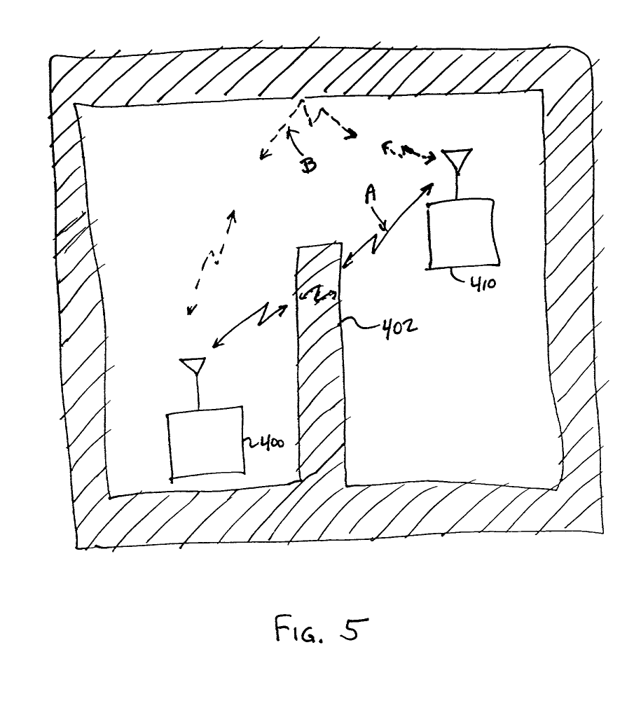

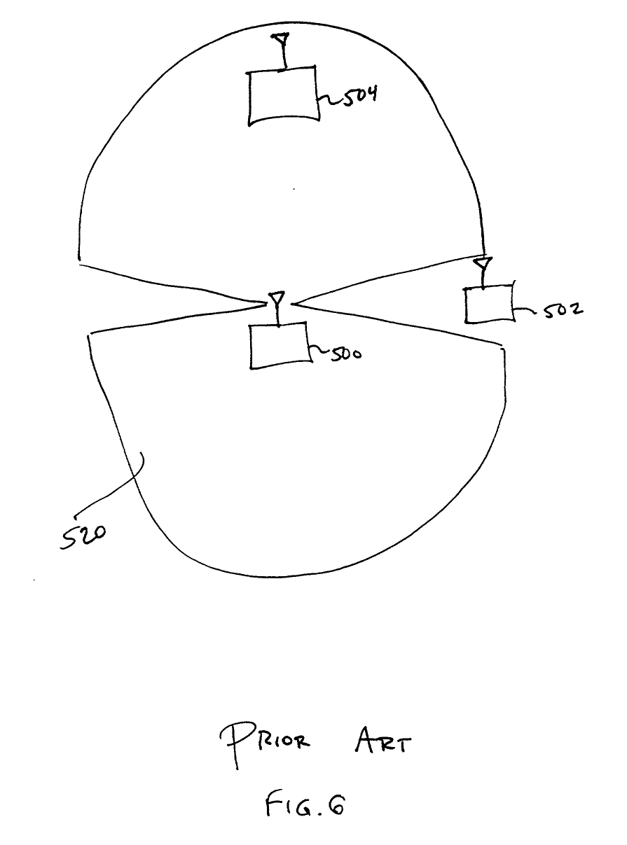

FIG. 4 shows an exemplary process of indicating wireless piconet connection quality to a user to allow the user to optimize the connection quality, in accordance with the principles of the present invention.

In particular, as shown in step 302 of FIG. 4, a user (e.g., a consumer who is typically non-technically inclined) places a new wireless piconet device in a suitable or desired location.

In step 304, the connection quality is determined by a piconet connection quality determiner 102 (FIG. 1) of the relevant wireless piconet device.

In step 306, the determined connection quality is indicated either audibly and/or visually to the user.

In step 308, the user determines whether or not the indicated output connection quality is optimal. If it is, the process ends. However, if the user wishes to see if a higher quality connection is possible, they may return to step 302 and re-place, move, rotate, etc. the relevant piconet device, and repeat the process.

In optimizing the placement of the wireless piconet device 110, the user may, e.g., walk around the short range area of the piconet (e.g., around a room) to get an initial idea as to undesirable locations or placements of the wireless piconet device (e.g., locations which show undesirable connection quality with one or more other wireless piconet devices in the piconet network). Thus, the indication to the user may be simply a warning mechanism that indicates when the location of the wireless piconet device is in a fringe area.

The present invention allows a user, particularly consumers who may be less technically inclined, to appreciate the expected link quality with a particular physical placement of wireless piconet devices.

In accordance with the principles of the present invention, a user may be provided with a warning that the wireless piconet device is about to utilize a longer range network connection, e.g., a scatternet, to increase range. The user may be provided with the option to allow or disallow the long range connection, e.g., because of an inherent reduction in data rate available using the longer range connection.

A piconet connection quality determiner and user link quality indicator in a piconet network in accordance with the principles of the present invention provides consumers with simple vision into optimization of the location of wireless piconet devices (e.g., BLUETOOTH wireless piconet devices).

The piconet connection quality determiner may be implemented easily in host application software operating a relevant BLUETOOTH wireless piconet device. The present invention has application in any piconet device, including cell phones, laptop computers, cordless telephones, etc.

Although the disclosed embodiments utilize RSSI and/or link quality parameters in indicating the quality of a wireless connection in a piconet device to a user, other parameters may be suitable for indication to the user, depending upon the particular application. For instance, data rate, error rate, piconet member address, piconet or scatternet connection information, and/or available bandwidth due to current bandwidth operations may be indicated to the user of the piconet device.

While the invention has been described with reference to the exemplary preferred embodiments thereof, those skilled in the art will be able to make various modifications to the described embodiments of the invention without departing from the true spirit and scope of the invention.

What is claimed is:

1. A wireless piconet device, comprising:
a piconet front end;
a piconet connection quality determiner; and
a user link quality indicator;
wherein said piconet connection quality determiner determines at least one aspect relating to a quality of connection achieved through said piconet front end, and controls said user link quality indicator based on said determined at least one aspect.

2. The wireless piconet device according to claim 1, wherein:
said piconet front end conforms to BLUETOOTH standards.

3. The wireless piconet device according to claim 1, wherein:
said user link quality indicator indicates audibly.

4. The wireless piconet device according to claim 1, wherein:
said user link quality indicator indicates visibly.

5. The wireless piconet device according to claim 4, wherein said visible user link quality indicator comprises:
an LED.

6. The wireless piconet device according to claim 4, wherein said visible user link quality indicator comprises:
a graphical display.

7. A method of optimizing link quality of a wireless piconet device to a user, comprising:
firstly determining at least one aspect of a link quality of a wireless connection to a short range network; and
providing a first indication of compliance of said at least one aspect of said link quality to said user.

8. The method of optimizing link quality of a wireless piconet device to a user in accordance with claim 7, further comprising:
allowing said user to physically move said wireless piconet device;
secondly determining said at least one aspect of said link quality; and
providing a second indication of compliance of said at least one aspect of said link quality to said user.

9. The method of optimizing link quality of a wireless piconet device to a user in accordance with claim 7, wherein said determining comprises:
generating a Read_RSSI command; and
retrieving an RSSI value returned in response to said generated Read_RSSI command.

10. The method of optimizing link quality of a wireless piconet device to a user in accordance with claim 7, wherein said determining comprises:
generating a Get_Link_Quality command; and
retrieving a link quality value returned in response to said generated Get_Link_Quality command.

11. The method of optimizing link quality of a wireless piconet device to a user in accordance with claim 7, wherein:
said wireless connection is a piconet connection.

12. The method of optimizing link quality of a wireless piconet device to a user in accordance with claim 7, wherein:
said wireless connection is a scatternet connection.

13. The method of optimizing link quality of a wireless piconet device to a user in accordance with claim 7, wherein:
said indication is audible.

14. The method of optimizing link quality of a wireless piconet device to a user in accordance with claim 7, wherein:
said indication is visible.

15. The method of optimizing link quality of a wireless piconet device to a user in accordance with claim 7, wherein:
said compliance is determined by a comparison of said determined at least one aspect to a pre-configured threshold value allowing optimal communications quality.

16. Apparatus for optimizing link quality of a wireless piconet device to a user, comprising:
means for firstly determining at least one aspect of a link quality of a wireless connection to a short range network; and
means for providing a first indication of compliance of said at least one aspect of said link quality to said user.

17. The apparatus for optimizing link quality of a wireless piconet device to a user in accordance with claim 16, further comprising:
means for allowing said user to physically move said wireless piconet device;
means for secondly determining said at least one aspect of said link quality; and
means for providing a second indication of compliance of said at least one aspect of said link quality to said user.

18. The apparatus for optimizing link quality of a wireless piconet device to a user in accordance with claim 16, wherein said means for determining comprises:
means for generating a Read_RSSI command; and
means for retrieving an RSSI value returned in response to said generated Read_RSSI command.

19. The apparatus for optimizing link quality of a wireless piconet device to a user in accordance with claim 16, wherein said means for determining comprises:
means for generating a Get_Link_Quality command; and
means for retrieving a link quality value returned in response to said generated Get_Link_Quality command.

20. The apparatus for optimizing link quality of a wireless piconet device to a user in accordance with claim 16, wherein:
said wireless connection is a piconet connection.

21. The apparatus for optimizing link quality of a wireless piconet device to a user in accordance with claim 16, wherein:
said wireless connection is a scatternet connection.

22. The apparatus for optimizing link quality of a wireless piconet device to a user in accordance with claim 16, wherein:
said indication is audible.

23. The apparatus for optimizing link quality of a wireless piconet device to a user in accordance with claim 16, wherein:
said indication is visible.

24. The apparatus for optimizing link quality of a wireless piconet device to a user in accordance with claim 16, wherein:
said compliance is determined by means for comparing said determined at least one aspect to a pre-configured threshold value allowing optimal communications quality.
